(19) United States
(12) Patent Application Publication
(10) Pub. No.: US 2006/0117373 A1
(43) Pub. Date: Jun. 1, 2006

(54) Data processing device, data recording/reproducing device, data processing method and program

(75) Inventor: Yoshimi Enomoto, Kashiwa-shi (JP)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/540,676

(22) PCT Filed: Dec. 15, 2003
(86) PCT No.: PCT/IB03/06095

§ 371 Date: Jun. 24, 2005

(30) Foreign Application Priority Data
Dec. 27, 2002 (JP) 2002-381052

(51) Int. Cl. H04N 7/173; H04N 7/16

(52) U.S. Cl. 725/134; 725/142; 725/89

(57) ABSTRACT

It is an object of the invention to provide a data processing device, a data processing method and a data processing program which can provide consistency between information of a macrovision signal and CGMS data added to an analogue video signal. A data processing device (10) receiving and analogue video signal (Sv?in#191) to which CGMS data and a macrovision signal are added is provided with a controller (33) having a determination means (33A), a rewrite means (33B) and a control means (33C). The CGMS data and the information of the macrovision signal are inputted from a CGMS decoder (31) and a macrovision detector (32), respectively, to the determination means (33A). In the determination means (33A), it is determined whether the information of the macrovision signal and the CGMS data conflict each other or not. When they conflict, the CGMS data is rewritten in the rewrite means (33B), after of which it is determined whether there is a conflict between them in the determination means (33A).

### BACKGROUND OF THE INVENTION

1. Field of the Invention

The present invention relates to a data processing device, data recording/reproducing device, and data processing method and program that process input data where copy protection information is added to an analogue video signal.

2. Description of the Related Art

Generally, when analogue audio video signals such as television broadcast signals are input to a data recording/reproducing device such as a video tape recorder (VTR), in order to prohibit an unauthorized copy of the signals, for example, the analogue video audio signals are given a macrovision signal and CGMS (Copy Generation Management System) data. The macrovision signal is to cause the video signals not to be recorded properly by inserting a false synchronization pulse into a horizontal retrace interval of video signal, and/or by inverting a phase of two lines or four lines of colour burst signal every 20 lines for a horizontal retrace interval to generate colour inversion. Further, the CGMS data is for use in determining whether or not it is permitted to copy video signals received in a data recording/reproducing device (for example, Japanese Laid-Open Patent Publication No. H10-93914 (pages 4 to 5)).

More specifically, the CGMS data is inserted into a vertical retrace interval of NTSC signal, and is comprised of two bits of copy control information control (CGMS-A information) and two bits of copy protection information. FIGS. 1A and 1B specifically illustrate the copy control information and copy protection information respectively. As can be seen from FIG. 1A, in the copy control information, “00” indicates copy free, “10” indicates permission of one-generation copy, “01” indicates prohibition of more copy, and “11” indicates prohibition of copy. Further, as can be seen from FIG. 1B, in the copy protection information, “00” indicates there is neither insertion of the false synchronization pulse nor phase inversion of the colour burst signal, “01” indicates there is insertion of the false synchronization pulse, “10” indicates there is insertion of the false synchronization pulse and two-line phase inversion of the colour burst signal, and “11” indicates there is insertion of the false synchronization pulse and four-line phase inversion of the colour burst signal.

FIG. 2 is a partial block diagram illustrating an example of a functional structure of the conventional data recording/reproducing device as described above. The signal processing device is a device that processes an analogue AV input signal S_{AVin} to which is added the CGMS data, and when necessary, the macrovision signal, and has a video A/D converter 111, a Y/C separator 112, a video data processor 113, a data linkage 114, a data storage 115, a video reproduction processor 116, a copy control data adding portion 117 and a video D/A converter 118. The signal-processing device further has a CGMS decoder 131, a macrovision detector 132, and a controller 133. For simplicity in description, descriptions of audio signal are omitted herein.

In the signal-processing device, an analogue video input signal S_{Vin} is converted into a digital signal in the video A/D converter 111, and separated into a luminance (Y) signal and colour (C) signal in the Y/C separator 112. The luminance signal and colour signal are subjected to predetermined processing in the video data processor 113, and supplied to the data linkage 114. The video data processor 113 extracts CGMS data and a portion where a macrovision signal should be added (hereinafter, referred to as a macrovision signal added portion), i.e., respective predetermined portions of the vertical retrace interval and horizontal retrace interval. The macrovision signal added portion is transmitted to the macrovision detector 132, which detects the presence or absence of a macrovision signal and a type of the macrovision signal. The CGMS data is transmitted to the CGMS data decoder 131 to be decoded, supplied to the controller 133, and added to the video data in the data linkage 114.

Then, when a mode (hereinafter, referred to as a direct reproducing mode) is selected where the analogue video input signal S_{Vin} is directly reproduced, the video data to which the CGMS data is added is outputted to the video reproduction processor 116. The section 116 performs the predetermined processing on the video data to output to copy control data adding portion 117. The section 117 adds the macrovision signal added portion from the macrovision detector 132 to the video data. The video D/A converter 118 converts the video data into an analogue signal, thereby generating an analogue video output signal S_{Vout} to which the CGMS data and information of the macrovision signal is added.

When a recording mode is selected, in the case where the CGMS data has the copy permitting information (the copy control information is “00” or “10”), the video data to which the CGMS data is added is transmitted to the data storage 115, and supplied to the data linkage 114 again at the time of readout/reproducing. At the time of readout/reproducing, as in the direct reproducing mode, the video data and CGMS data supplied to the data linkage 114 is transmitted to the copy control data-adding portion 117 via the video reproduction controller 116. The CGMS data is also transmitted to the controller 133, and based on the CGMS data, the information of the macrovision signal is generated. The generated information of the macrovision signal is added to the video data in the copy control data adding portion 117, and the video data is converted into an analogue signal in the video D/A converter 118, thus generating an analogue video output signal S_{Vout} to which the CGMS data and the information of the macrovision signal is added.

Thus, in the conventional signal processing device as described above, in the direct reproducing mode, the macrovision signal and CGMS data is separated in the device, then passed through respective separate paths, and added to a video signal separately (the macrovision signal is added in the copy control data adding portion 117, while the CGMS data is added in the data linkage 114).

Therefore, inconveniences occur when a case arises where the information of the macrovision signal and the content of the CGMS data do not agree with each other due to a transmission error, for example).

Specifically, when a video signal to which is added a macrovision signal and CGMS data (with copy control information of “11” or “01”) having copy prohibiting information is inputted in such a state that CGMS data having copy permitting information is added due to a transmission error, in the direct reproducing mode, a video output signal S_{Vout} is outputted to which is added the macrovision signal and CGMS data having the copy permitting information. When such an output video signal is recorded, the recording is enabled because the CGMS data has the copy permitting information, but since the macrovision signal is added, the signal is not recorded properly and the video is distorted and not reproduced accurately. As a result, inconveniences arise such that a viewer misunderstands that the data recording/reproducing device or a display device that displays the video is failure.

In addition, when processing a digital video input signal S_{AVin}, a macrovision signal generator exists in a digital data processing device corresponding to the analogue data processing device as described above, and the macrovision signal generator adds a macrovision signal to the video signal (for example, see Patent Document 1, page 4). Therefore, unlike the case where analogue signals are inputted, there is considered no possibility that the information of the macrovision signal and the content of the CGMS data do not agree with each other.

### SUMMARY OF THE INVENTION

In view of the foregoing, it is an object of the present invention to provide a data processing device, a data recording/reproducing device and a data processing method and program which can provide consistency between information of a macrovision signal and CGMS data added to an analogue video signal.

A data processing device according to the present invention is a device for receiving data including an analogue video signal, first additional information indicating permission/prohibition of recording the analogue video signal on an apparatus and second additional information for preventing the video signal from being recorded, and for processing the data, and is characterized in that the data processing device comprises a determination means for determining whether the permission/prohibition of recording indicated by the first additional information and the second additional information conflict each other or not, and a rewrite means for rewriting the first additional information in accordance with the second additional information when the first additional information and the second additional information contradict. Further, a data recording/reproducing device according to the present invention is characterized by comprising the aforementioned data processing device. In addition, herein “recording” includes temporary recording.

A data processing method according to the present invention is a method for processing input data including an analogue video signal, first additional information indicating permission/prohibition of recording the analogue video signal on an apparatus and second additional information preventing the video signal from being recorded, and is characterized in that the data processing method includes a determination step for determining whether the permission/prohibition of recording or temporary storage indicated by the first additional information and the second additional information conflict each other or not, and a rewrite step for rewriting the first additional information in accordance with the second additional information when the first additional information and the second additional information conflict.

In the data processing device, data recording/reproducing device or data processing method according to the present invention, it is determined whether the permission/prohibition of recording indicated by the first additional information and the second additional information conflicts with each other or not, and the first additional information is rewritten in accordance with the second additional information when the first and second additional information conflicts with each other. Therefore, even when the first and second additional information conflicts with each other when inputted, the consistency is provided between the both information. Accordingly, it is possible to prevent conflicting information from being outputted.

As the first additional information, for example, there is CGMS data. As the second additional information, for example, there is information about the video signal is subjected to scramble or not and about such a scramble, and information about the presence or absence of a macrovision signal and a type of the macrovision signal.

When the first additional information includes copy protection information for preventing the video signal from being recorded and copy control information for controlling an allowable copy generation, it is preferable that the determination means determines whether the copy protection information of the first additional information and the second additional information agree with respect to each other or not and whether the copy control information of the first additional information and the second additional information conflict each other or not, and determines that the permission/prohibition of recording or temporary storage indicated by the first additional information and the second additional information do not conflict each other when the copy protection information of the first additional information and the second additional information agree and when the copy control information of the first additional information and the second additional information do not conflict.

A program according to the present invention is a program operable on a computer, and is characterized in that the program includes a procedure for determining whether or not first additional information indicating permission/prohibition of recording an analogue video signal on an apparatus conflicts with second additional information for preventing the video signal from being recorded, and a procedure for rewriting the first additional information in accordance with the second additional information when the first additional information and the second additional information conflict.

### BRIEF DESCRIPTION OF THE DRAWINGS

FIG. 1A is an illustration showing copy control information of the CGMS data;

FIG. 1B is an illustration showing copy protection information of the CGMS data;

FIG. 2 is a block diagram illustrating a functional structure of a conventional data processing device;

FIG. 3 is a block diagram illustrating a functional structure of a data processing device according to an embodiment of the invention;

FIG. 4 is an illustration showing details of a determination means and a rewrite means of the data processing device shown in FIG. 3;

FIG. 5 is another illustration showing details of a determination means and a rewrite means of the data processing device shown in FIG. 3;

FIG. 6 is a flowchart for illustrating an operation of the data processing device shown in FIG. 3;

FIG. 7 is another flowchart for illustrating an operation of the data processing device shown in FIG. 3; and

FIG. 8 is further flowchart for illustrating an operation of the data processing device shown in FIG. 3.

### DESCRIPTION OF THE PREFERRED EMBODIMENT(S)

An embodiment of the present invention will be described specifically below with reference to accompanying drawings.

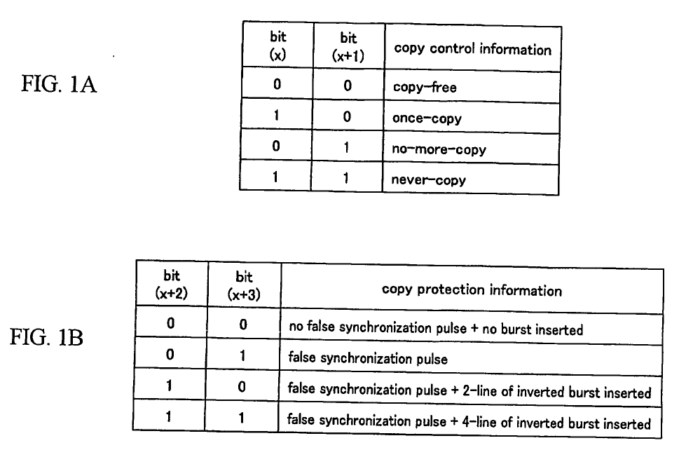

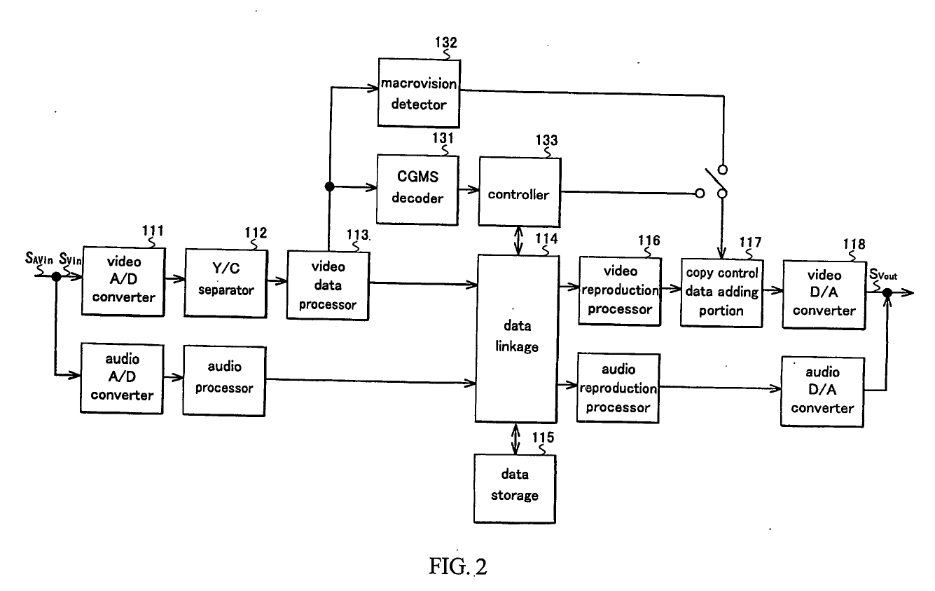

A structure of a data processing device according to an embodiment of the present invention will be described first with reference to FIGS. 3 to 5 and FIG. 1.

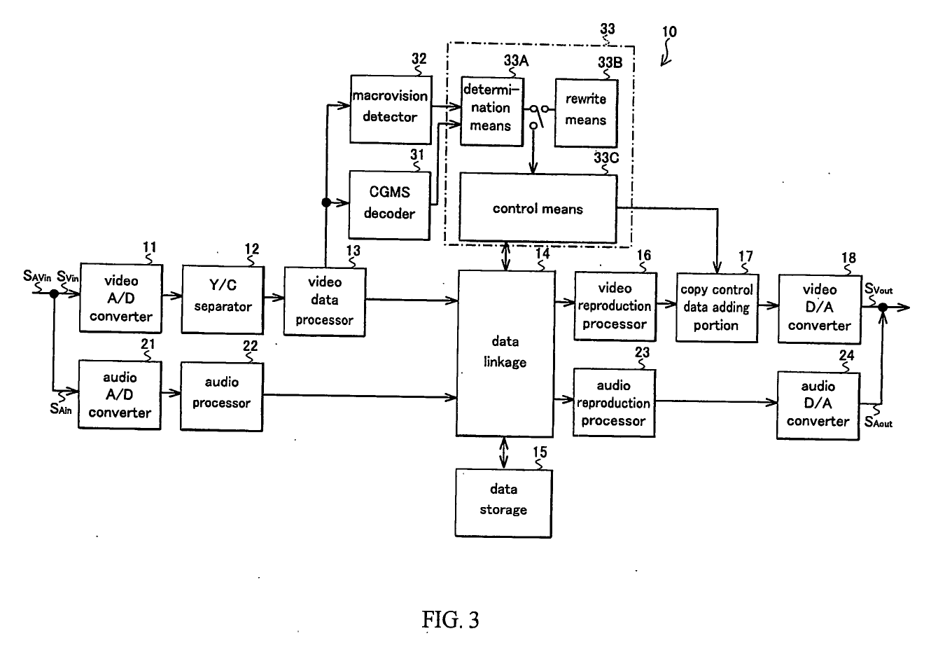

FIG. 3 is a block diagram illustrating a functional structure of a data processing device 10 according to this embodiment. The data processing device 10 receives data including analogue (NTSC) audio video signal S_{AVin} to which is added CGMS data, and when necessary, a macrovision signal, and processes the data. The data processing device 10 is used in a data recording/reproducing device such as a television receiver provided with a storage medium enabling digital recording such as a HDD (hard disk drive), for example.

The data processing device 10 is provided with a video A/D converter 11 that converts a video signal S_{Vin} of an analogue AV input signal S_{AVin} into a digital signal, a Y/C separator 12 that separates a luminance (Y) signal component and colour (C) signal component from the digital video data, a video data processor 13 which performs colour demodulation, etc. using the luminance signal and colour signal to generate a colour difference signal, while extracting the CGMS data and the macrovision signal added portion, an audio AID converter 21 that converts an audio signal S_{AVin} of the analogue AV input signal S_{AVin} into a digital signal, an audio processor 22 that formats the digital audio data, and a data linkage 14 that receives the colour difference signal generated in the video data processor 13 and the audio data processed in the audio processor 22. The data processing device 10 is further provided with a data storage 15 that stores the video data and audio data in the recording mode or temporary recording mode, a video reproduction processor 16 that generates an RGB signal from the colour difference signal, a copy control data adding portion 17 that adds information of the macrovision signal to the generated RGB signal, a video D/A converter 18 that converts the RGB signal into an analogue signal to generate analogue video output signal S_{Vout}, an audio reproduction processor 23 that processes the formatted audio data, and an audio D/A converter 24 that converts the audio data into an analogue signal to generate an analogue audio output signal S_{Vout}.

Further, the data processing device 10 is provided with a CGMS decoder 31 which receives the CGMS data extracted in the video data processor 13 and decodes the CGMS data, and a macrovision detector 32 which receives the macrovision signal added portion extracted in the video data processor 13, detects whether or not a macrovision signal exists, and when the macrovision signal exists, further detects a type of the macrovision signal (hereinafter, such information is referred to as information of the macrovision signal). In addition, the extracted CGMS data is inserted into a vertical retrace interval of the video signal S_{Vin} represented by 20 bits, and includes 2 bits of the copy control information (see FIG. 1A) for controlling an allowable copy generation, and 2 bits of the copy protection information (see FIG. 1B) for preventing the video signal from being recorded. The macrovision signal is inserted into a horizontal retrace interval of the video signal S_{Vin}.

Furthermore, the data processing device 10 is provided with a controller 33 that receives the CGMS data from the CGMS data decoder 31 and the information of the macrovision signal from the macrovision detector 32. The controller 33 has determination means 33a for determining whether the information of the macrovision signal and the information of the CGMS data conflicts with each other or not, rewrite means 33B for rewriting the CGMS data in accordance with the information of the macrovision signal when the information of the macrovision signal and of CGMS data conflicts with each other, and control means 33C for receiving the CGMS data and the information of the macrovision signal that does not conflict with each other from the determination means 33A.

More specifically, for example, the determination means 33A first determines whether or not the information of the macrovision signal supplied from the macrovision detector 32 agrees with the copy protection information of the CGMS data, and then, determines whether or not the information of the macrovision signal conflicts with the copy control information of the CGMS data. As a result of the determination, in the case where the information of the macrovision signal and the copy protection information of the CGMS data agrees with each other and the information of the macrovision signal and the copy control information of the CGMS data does not conflict with each other, the determination means 33A determines that the information of the macrovision signal and the CGMS data does not conflict with each other. In other cases, i.e., in the case where the information of the macrovision signal does not agree with the copy protection information of the CGMS, or where the information of the macrovision signal agrees with the copy protection information of the CGMS data, while the information of the macrovision signal and the copy control information of the CGMS data conflicts with each other, the determination means 33A determines that the information of the macrovision signal and the CGMS data conflicts with each other. When the determination means 33A determines that the macrovision signal and the CGMS data does not contradict, the CGMS data is not rewritten, and the CGMS data and the macrovision signal is supplied to the control means 33C. Meanwhile, when the determination means 33A determines that the macrovision signal and the CGMS data contradicts, the determination means 33A supplies the CGMS data to the rewrite means 33B so as to rewrite the CGMS data.

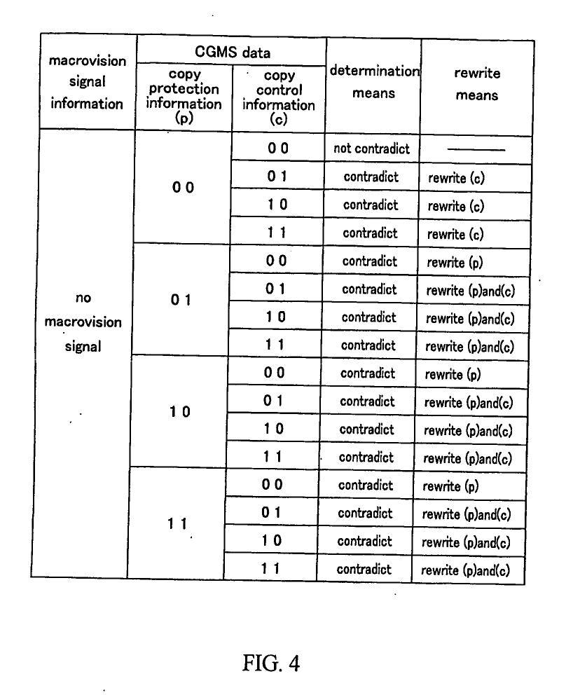

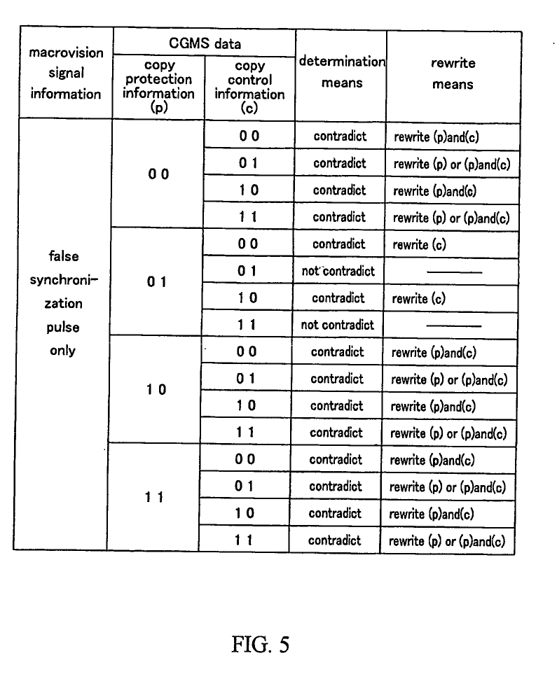

FIGS. 4 and 5 are illustrations each showing a specific example of the relationship between the macrovision signal, CGMS data, determination in the determination means 33A and rewriting in rewrite means 33B. When a macrovision is not added (FIG. 4), it is determined that the information of the macrovision signal and the copy protection information agrees with each other if the copy protection information of the CGMS data is “00”, while it is determined that the information of the macrovision signal and the copy protection information does not agree with each other if the copy protection information of the CGMS data is “01”, “10” or “11”. Further, it is determined that the copy control information and the macrovision signal does not conflict with each other if the copy control information is “00”, while it is determined that the copy control information and the macrovision signal conflicts with each other if the copy control information is “01”, “00” or “11”. Accordingly, in the case where a macrovision signal is not added, the macrovision signal and the CGMS data is determined not to contradict in the case where the CGMS data has the copy protection information of “00” and the copy control information of “00”, while being determined to contradict in the other cases.

When a false synchronization pulse is only inserted as a macrovision signal (FIG. 5), it is determined that the macrovision signal and the copy protection information agrees with each other if the copy protection information of the CGMS data is “01”, while it is determined that the macrovision signal and the copy protection information does not agree with each other if the copy protection information of the CGMS data is “00”, “10” or “11”. Further, it is determined that the copy control information and the macrovision signal does not conflict with each other if the copy control information is “01” or “11”, while it is determined that the copy control information and the macrovision signal conflicts with each other if the copy control information is “00” or “01”. Accordingly, in the case where a false horizontal synchronization pulse is only added as a macrovision signal, the macrovision signal and the CGMS data is determined not to contradict in the case where the CGMS data has the copy protection information of “01” and the copy control information of “01” or “11”, while being determined to contradict in the other cases.

In addition, when a false horizontal synchronization pulse and two-line or four-line phase-inverted colour burst signal are inserted as a macrovision signal, the determination is also made in the same was as described above, which is not described specifically.

The determination means 33A makes the above-mentioned determination on a frame basis, for example. A single frame has a plurality of macrovision signal added portions and a single CGMS data added portion. Regarding the information of the macrovision signal, there is a possibility that different kinds of information exist in a frame due to transmission errors. In this case, for example, every three to five frames are grouped, and when there is a difference between respective determination results of the frames, it may be possible to adopt a larger number of results as a final determination result of the frames.

The rewrite means 33B rewrites the CGMS data supplied from the determination means 33A as described below, for example. In other words, when the means 33B receives the CGMS data with the copy protection information that is determined not to agree with the information of the macrovision signal the means 33B rewrites the copy protection information of the CGMS data to agree with the macrovision signal, and then rewrites the copy control information not to conflict with the macrovision signal, when necessary. Further, when the means 33B receives the CGMS data with the copy protection information agreeing with the information of the macrovision signal and with the copy control information determined to conflict with the information of the macrovision signal, the means 33B rewrites only the copy control information not to conflict with the macrovision signal. In addition, when a plurality of rewritable candidates exists in rewriting the copy control information, it is preferable to set so as to rewrite more strictly.

Specifically, for example, when a false horizontal synchronization pulse is only inserted as a macrovision signal (FIG. 5), the copy protection information of the CGMS data is “01” and the copy control information of the CGMS data is “00”, in other words, when the macrovision signal agrees with the copy protection information, while conflicting with the copy control information, although the rewrite means 33B is capable of rewriting the copy control information to “01” (no-more-copy) or “11” (never-copy), the means 33B rewrites to “11” that is stricter. Further, when a false horizontal synchronization pulse is only inserted as a macrovision signal, the copy protection information of the CGMS data is “00” and the copy control information of the CGMS data is “01”, the rewrite means 33B rewrites the copy protection information to “01”. Then, although it is not necessarily required to rewrite the copy control information, a case is expected of rewriting the copy control information to “11” that is stricter.

After rewriting the information, the rewrite means 33B supplies the CGMS data to the determination means 33A In this case, the determination means 33A having received the rewritten CGMS data determines again whether the information of the macrovision signal and the information of the CGMS data conflicts with each other according to, for example, the above-mentioned method, and when determining that the information does not conflict with each other, supplies the CGMS data to the control means 33C, while when determining the information conflicts, supplies the CGMS data to the rewrite means 33B.

The control means 33C supplies the CGMS data determined not to conflict in the determination means 33A to the data linkage 14. In operating in the recording mode, the control means 33C changes the CGMS data when required. For example, the control means 33C changes “10” (once-copy) of the copy control information to “01” (no-more-copy). In this case, the copy protection information is also changed in response to the change. In operating in the readout/reproducing mode, the control means 33C receives the CGMS data from the data storage 15 via the data linkage 14, reconstructs the information of the macrovision signal from the copy protection information of the CGMS data, and transmits the reconstructed information of the macrovision signal to the copy control data adding portion 17. In operating in the direct reproducing mode, the control means 33C transmits the information of the macrovision signal from the determination means 33A to the copy control data-adding portion 17.

The operation of the data processing device with the aforementioned structure will be described below with reference to FIG. 3 and FIGS. 6 to 8. In addition, explanations below also describe a data processing method according to this embodiment.

When the analogue AV input signal S_{AVin} is inputted to which is added CGMS data, and when necessary, a macrovision signal, the video signal S_{Vin} and audio signal S_{Ain} are extracted. The extracted audio signal S_{Ain} is converted into a digital signal in the audio AD converter 21, and is formatted in the audio processor 22. Meanwhile, the extracted video signal S_{Vin} is converted into a digital signal in the video A/D converter 11, separated into a luminance signal component and colour signal component in the Y/C separator 12, undergoes the predetermined processing in the video data processor 13 to be a colour difference signal, and supplied to the data linkage 14. The video data processor 13 extracts the CGMS data and macrovision signal added portion, and supplies the CGMS data to the CGMS decoder 31, and the macrovision signal added portion to the macrovision detector 32. The CGMS decoder 31 decodes the CGMS data, and supplies the decoded data to the determination means 33A in the controller 33. The macrovision detector 32 detects whether or not a macrovision signal is added, further detects a type of the macrovision signal when the macrovision signal is added, and transmits the detected result to the determination means 33A.

The aforementioned operation is common to the operation in either the recording mode, reproducing mode or temporary storage mode in the device. The operation in each mode will be described below.

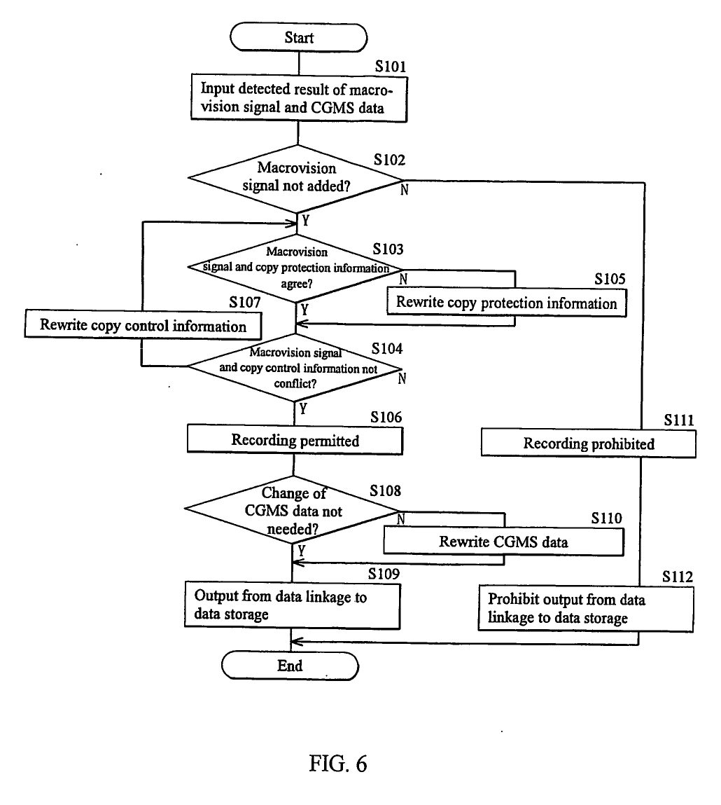

FIG. 6 is a flowchart for illustrating the processing in the controller 33 in the recording mode.

In the recording mode, in the controller 33, when a detection result on the macrovision signal and the CGMS data is inputted to the determination means 33A (step S101), the means 33A determines whether a macrovision signal is added or not (step S102). When the macrovision signal is not added (step S102;Y), the means 33A subsequently determines whether the macrovision signal and the copy protection information of the CGMS data agrees with each other (step S103). When determining that they agree (step S103;Y), the means 33A determines whether the macrovision signal and the copy control information of the CGMS data conflicts with each other or not (step S104). Meanwhile, when determining that they do not agree (step S103;N), the copy protection information of the CGMS data is rewritten to agree with the macrovision signal (step S105), and then, the means 33A determines whether the macrovision signal and the copy control information of the CGMS data conflicts with each other (step S104).

When determining that the macrovision signal and the copy control information does not conflict with each other (step S104;Y), the macrovision signal and the CGMS data is determined not to contradict, and is inputted to the control means 33C, and it is determined that the recording of the video input signal S_{Vin} is permitted (step S106). When determining that the macrovision signal and the copy control information conflicts with each other (step S104;N), the copy control information is rewritten not to conflict with the macrovision signal (step S107), and it is determined again whether the macrovision signal and the copy protection information of the CGMS data agrees with each other (step S103). Accordingly, the consistency is always provided between the information of the macrovision signal and the CGMS data respectively inputted from the macrovision detector and the CGMS decoder to the determination means 33A, when the information of the macrovision signal and the CGMS data is supplied to the control means 33C.

After it is determined that the recording of the video input signal S_{Vin} is permitted (step S106), the control means 33C determines whether changes of CGMS data are needed (step S108). When changes of the CGMS data are not needed (step S108;Y), an instruction for instructing the data linkage 14 to output the video data, audio data and CGMS information to the data storage 15 is transmitted to the data linkage 14 (step S109). When changes of the CGMS data are needed (step S108;N), the CGMS data is rewritten (step S110). Then, the instruction for instructing the data linkage 14 to output the video data, audio data and CGMS information to the data storage 15 is transmitted to the data linkage 14 (step S109). When the instruction is transmitted, the CGMS data is supplied to the data linkage 14, and in response to the instruction, the data linkage 14 outputs the video data, audio data and CGMS information to the data storage 15.

Meanwhile, when the macrovision signal is added (step S102;N), the CGMS data is inputted to the control means 33C, the control means 33C determines that the recording of the video input signal S_{Vin} is prohibited (step S111), and an instruction for prohibiting the data linkage 14 from outputting the video data and audio data to the data storage 15 is transmitted to the data linkage 14 (step S112).

Thus, in the recording mode, when the video data and audio data stored in the data storage 15 is read out to be reproduced (hereinafter, referred to as a readout/reproducing mode), the video data, audio data and CGMS data is supplied from the data storage 15 to the data linkage 14 if the readout/reproducing instruction is outputted. Among the data, the audio data is processed in the audio reproduction processor 23, and converted into the analogue signal in the audio D/A converter 24, and the analogue audio output signal S_{Aout} is thus generated.

Meanwhile, the video data is transformed into the RGB signal in the video reproduction processor 16, and supplied to the copy control data-adding portion 17. The CGMS data is added to the video data, and supplied to the copy control data adding portion 17 via the video reproduction processor 16, while being supplied to the control means 33C. The control means 33C reconstructs the information of the macrovision signal from the copy protection information of the CGMS data, and transmits the decoded information of the macrovision signal to the copy control data-adding portion 17. In this case, the information of the macrovision signal is reconstructed from the CGMS data having consistency with the information of the macrovision signal added to the video input signal S_{Vin} in the recording mode, and therefore, reflects the information of the macrovision signal added to the video input signal S_{Vin} in decoding, as distinct from the conventional device.

The copy control data adding portion 17 adds the information of the macrovision signal to the video data, and supplies the video data with the CGMS data and the information of the macrovision signal added thereto to the video D/A converter 18. The video D/A converter 18 converts the video data into the analogue signal, and thus, the analogue video output signal S_{Vout} to which the CGMS data and the information of the macrovision signal is added is generated and outputted from the data processing device 10 together with the above-mentioned analogue audio output signal S_{Aout}.

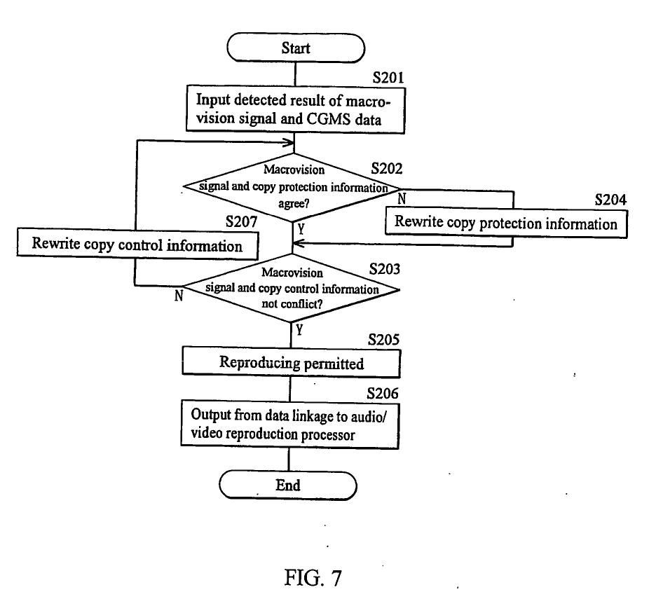

FIG. 7 is a flowchart for illustrating the processing in the controller 33 when the AV input signal S_{AVin} is directly reproduced (direct reproducing mode). In the direct reproducing mode, when a detection result on the macrovision signal and the CGMS data is inputted to the determination means 33A (step S201), the means 33A determines whether the information of the macrovision signal and the copy protection information of the CGMS data agrees with each other (step S202). When determining that they agree (step S202;Y), the means 33A determines whether the information of the macrovision signal and the copy control information of the CGMS data conflicts with each (step S203). When determining that they do not agree (step S202;N), the copy protection information of the CGMS data is rewritten to agree with the information of the macrovision signal (step S204). Then, the means 33A determines whether the information of the macrovision signal and the copy control information conflicts with each other (step S203).

When the information of the macrovision signal and the copy control information does not conflict with each other (step S203;Y), the information of the macrovision signal and the CGMS data is determined not to contradict, and is inputted to the control means 33C. The control means 33C determines that the reproducing of the video input signal S_{Vin} is permitted (step S205), and transmits to the data linkage 14 an instruction for instructing the data linkage 14 to output the video data and CGMS information to the video reproduction processor 16 and the audio data to the audio reproduction processor 23 (step S206). Meanwhile, when the information of the macrovision signal and the copy control information conflicts with each other (step S203;N), the copy control information is rewritten not to conflict with the information of the macrovision signal (step S207), and then, it is determined again whether the information of the macrovision signal and the copy protection information of the CGMS data agrees with each other or not (step S202). Accordingly, also in this case, as in the recording mode, the consistency is always provided between the information of the macrovision signal and the CGMS data inputted to the determination means 33A, when the information of the macrovision signal and the CGMS data is supplied to the control means 33C.

When the control means 33C transmits the instruction to the data linkage 14 (step S206), the CGMS data is supplied to the data linkage 14, and in response to the instruction, the data linkage 14 outputs the video data and CGMS information, and audio data respectively to the video reproduction processor 16 and the audio reproduction processor 23. The subsequent operation is the same as in the readout/reproducing mode as described above except that the control means 33C transmits the information of the macrovision signal transmitted from the determination means 33A to the copy control data adding portion 17.

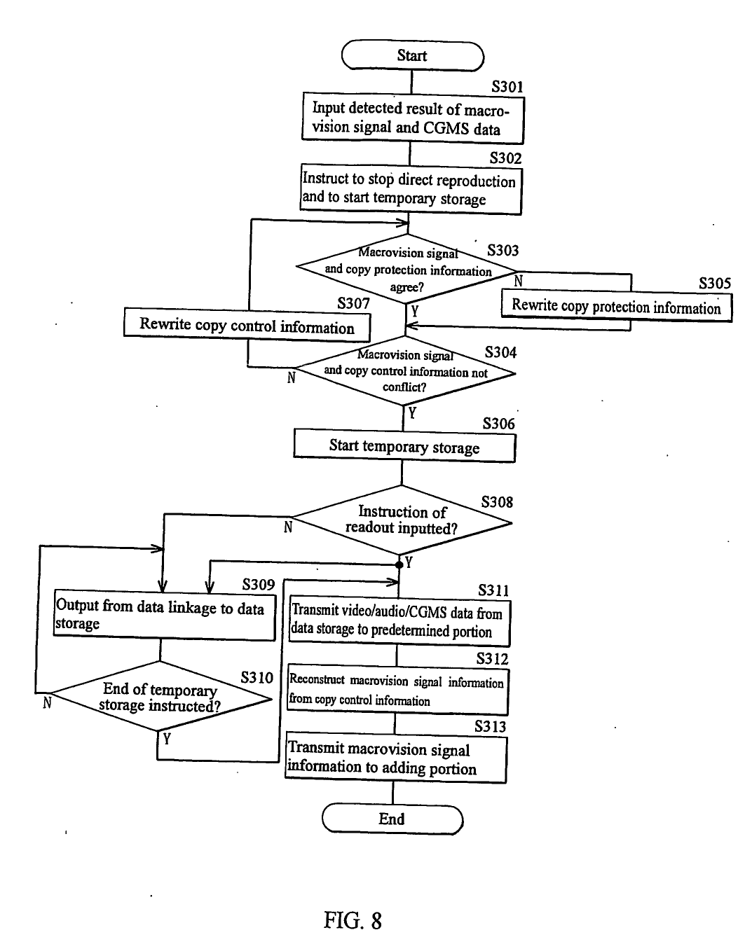

FIG. 8 is a flowchart for illustrating the processing in the controller 33 in the case of so-called time shift reproducing (hereinafter, also referred to as a temporary storing mode) where viewing of an on-air television program is temporarily stopped and then resumed. In addition, as an example, the time shift reproducing will be described herein in the case where copy prohibiting information is added that has been proposed in recent years.

With a detection result on the macrovision signal and CGMS data inputted to the determination means 33A (step S301), when an instruction is provided for instructing to stop direct reproduction and to start temporary storage (step S302), it is determined whether the macrovision signal and the copy protection information of the CGMS data agrees with each other or not (step S303). When they agree (step S303;Y), it is determined whether the macrovision signal and the copy control information of the CGMS data conflicts with each other (step S304). When the macrovision signal and copy protection information does not agree with each other (step S303;N), the copy protection information is rewritten to agree with the macrovision signal (step S305), and then, it is determined whether the macrovision signal and the copy control information of the CGMS data conflicts with each other (step S304).

When the macrovision signal and the copy control information does not conflict with each other (step S304;Y), the macrovision signal and the CGMS is determined not to contradict, and is inputted to the control means 33C data, where it is determined that the temporary storage of the video input signal S_{Vin} is permitted, and the temporary storage is started (step S306). Meanwhile, when the macrovision signal and the copy control information conflicts with each other (step S304;N), the copy control information is rewritten not to conflict with the macrovision signal (step S307), and then, it is determined again whether the macrovision signal and the copy protection information of the CGMS data agrees with each other or not (step S303).

After the temporary storage is started (step S306), the control means 33C determines whether an instruction for reading out the temporarily stored data is inputted or not (step S308), and when the instruction is not inputted (step S308;N), transmits to the data linkage 14 an instruction for instructing the data linkage 14 to output the video data, audio data and CGMS information to the data storage 15 (step S309). When the instruction is transmitted, the CGMS data is supplied to the data linkage 14, and in response to the instruction, the data linkage 14 outputs the video data, audio data and CGMS information to the data storage 15. The operation lasts until it is determined that an instruction for ending the temporary storage is provided. (S310;Y) in determining whether the instruction for ending the temporary storage is provided or not (step S310).

Meanwhile, when the instruction for reading out the temporarily stored data is inputted (step 308;Y), the above-mentioned instruction is transmitted to the data linkage 14 (step S309), while the video data, audio data and CGMS data is transmitted to predetermined portions from the data storage 15 via the data linkage 14 (S311). In other words, the video data is transmitted to the copy control data adding portion 17 via the video reproduction processor 16, the audio data is transmitted to the audio reproduction processor 23, and the CGMS data is transmitted to the copy control data adding portion 17 via the video reproduction processor 16, while being transmitted to the control means 33C. The subsequent operation is the same as in the readout/reproducing mode as described above such that the control means 33C reconstructs the information of the macrovision signal from the copy protection information of the CGMS data (S312), and transmits the reconstructed information of the macrovision signal to the copy control data adding portion 17 (S313).

Thus, according to this embodiment, it is determined whether the information of the macrovision signal and CGMS data conflicts with each other, and when they conflict with each other, the CGMS data is rewritten in accordance with the information of the macrovision signal, whereby it is possible to provide consistency between the information of the macrovision signal and CGMS data inputted to the controller 33. Accordingly, there is no fear that the conflicting information of the macrovision signal and CGMS data is outputted. Further, in the recording mode, a macrovision output signal is generated from the CGMS data in which a macrovision input signal is reflected.

Further, when the information of the macrovision signal and CGMS data conflicts with each other, the CGMS data is rewritten, and then it is determined again whether the information of the macrovision signal and CGMS data conflict with each other, whereby it is possible to further increase the reliability in the consistency as described above.

Furthermore, generally, since the CGMS data varies on a program (event) basis and the macrovision signal varies on a content basis, there arises a case that the macrovision input signal only varies due to the insertion of television commercial, while the CGMS input data does not vary. However, in such a case, it is possible to provide consistency between the CGMS data and the information of the macrovision signal inputted to the controller 33.

As described above, the present invention is described with reference to the embodiment. However, the present invention is not limited to the aforementioned embodiment, and is capable of being carried into practice with various modifications thereof For example, while the aforementioned embodiment describes that the processing of the information of the macrovision signal and of the CGMS data as a data processing device, it may be possible that such data processing is constructed with software. For example, it may be possible that a data processing program according to the present invention is stored in ROM (Read Only Memory), and according to the program, the operation is performed by instructions of CPU (Central Processing Unit). Further, it may be possible that the program is stored in a computer readable storage medium, the data processing program in the storage medium is recorded in RAM (Random Access Memory) in a computer, and that the operation is performed according to the data processing program. Such cases also provide the same functions and effects as in the above-mentioned embodiment.

The embodiment describes the case where in the recording mode, the CGMS data is rewritten (FIG. 6, step S110), and then the control means 33C outputs an instruction for instructing the data linkage to output the video data, etc. to the storage. Further, it may be possible that the CGMS data is rewritten, the control means 33C provides the CGMS data and the information of the macrovision signal to the determination means 33A, and the means 33A determiines whether the rewritten CGMS data and the macrovision signal conflicts with each other (steps S103 and S104).

Further, the embodiment describes the case where in the readout/reproducing mode, the control means 33C reconstructs the information of the macrovision signal, and then transmits the information to the copy control data adding portion 17. Moreover, it may be possible that the control means 33C reconstructs the information of the macrovision signal, and then supplies the CGMS data and the information of the macrovision signal to the determination means 33A, and the means 33A determines whether the reconstructed information of the macrovision signal and the CGMS data conflicts with each other.

While the embodiment describes the time shift reproducing where viewing of an on-air television program is temporarily stopped and then resumed, the present invention is effective in time shift reproducing where an on-air television program is recorded, while reproducing the program starting with the beginning at any time.

Further, the embodiment describes the time shift reproducing where the copy prohibiting information is added and the CGMS data is not changed in the temporary storage. However, the present invention is effective in performing time shift reproducing where the copy permitting information is added and the CGMS data is changed in the temporary storage.

Furthermore, while the embodiment describes the case of performing the processing of the temporary storing mode, it may be possible to perform only the processing of the storing mode, the readout/reproducing mode and the direct reproducing mode without performiing the processing of the temporary storing mode.

Still furthermore, while the embodiment describes the case where an analogue video signal to which the information of the macrovision signal is added is inputted, the present invention is applicable to the case where an analogue video signal to which the information of a scramble signal other than a macrovision signal is added is inputted. Further, while the embodiment describes about signals in the NTSC system where CGMS data is added, the present invention enables signals in the PAL system where WSS data is added, or the like to be processed in a similar way.

Moreover, the present invention is applicable widely to cases where analogue video signals are inputted to which is added additional information indicative of whether to permit or prohibit the recording or temporary storage of the analogue signal and additional information for preventing the video signal from being recorded.

As described above, according to the present invention, it is determined whether the permission/prohibition of recording or temporary storage indicated by the first additional information and the second additional information conflicts with each other or not, and the first additional information is rewritten in accordance with the second additional information when the first and second additional information conflicts with each other. Therefore, it is possible to provide consistency between the permission/prohibition of recording or temporary storage indicated by the first additional information and the second additional information. Accordingly, even in the case where the first and second additional information conflicts with each other when inputted or the like, it is possible to prevent conflicting information from being outputted.

This application is based on the Japanese Patent Application No 2002-381052 filed on Dec. 27, 2002, entire content of which is expressly incorporated by reference herein.

1. A data processing device for receiving data including an analogue video signal, first additional information indicating permission/prohibition of recording the analogue video signal on an apparatus and second additional information for preventing the video signal from being recorded, and for processing the data, characterized in that said data processing device comprises:
a determination means for determining whether the permission/prohibition of recording indicated by the first additional information and the second additional information conflict each other or not; and
a rewrite means for rewriting the first additional information in accordance with the second additional information when the first additional information and the second additional information contradict.

2. A data processing device as claimed in claim 1, characterized in that the second additional information is information about whether the video signal is subjected to a scramble or not and about such a scramble.

3. A data processing device as claimed in claim 1, characterized in that the second additional information is information about the presence or absence of a macrovision signal and a type of the macrovision signal.

4. A data processing device as claimed in claim 1, characterized in that the first additional information is a CGMS data.

5. A data processing device as claimed in claim 1, characterized:
in that the first additional information includes copy protection information for preventing the video signal from being recorded and copy control information for controlling an allowable copy generation; and
in that the determination means determines whether the copy protection information of the first additional information and the second additional information agree with respect to each other or not and whether the copy control information of the first additional information and the second additional information conflict each other or not, and determines that the permission/prohibition of recording indicated by the first additional information and the second additional information do not conflict each other when the copy protection information of the first additional information and the second additional information agree and when the copy control information of the first additional information and the second additional information do not conflict.

6. A data recording/reproducing apparatus comprising a data processing device as claimed in 1.

7. A data processing method for processing input data including an analogue video signal, first additional information indicating permission/prohibition of recording the analogue video signal on an apparatus and second additional information preventing the video signal from being recorded, characterized in that said data processing method includes:
a determination step for determining whether the permission/prohibition of recording indicated by the first additional information and the second additional information conflict each other or not; and
a rewrite step for rewriting the first additional information in accordance with the second additional information when the first additional information and the second additional information conflict.

8. A program operable on a computer, characterized in that said program includes:
a procedure for determining whether first additional information indicating permission/prohibition of recording an analogue video signal on an apparatus and second additional information for preventing the video signal from being recorded, and for processing the data conflict each other or not; and
a procedure for rewriting the first additional information in accordance with the second additional information when the first additional information and the second additional information conflict.

9. A program as claimed in claim 8, characterized:
in that the first additional information includes copy protection information for preventing the video signal from being recorded and copy control information for controlling an allowable copy generation; and
in that the determination procedure determines whether the copy protection information of the first additional information and the second additional information agree with respect to each other or not and whether the copy control information of the first additional information and the second additional information conflict each other or not, and determines that the permission/prohibition of recording indicated by the first additional information and the second additional information do not conflict each other when the copy protection information of the first additional information and the second additional information agree and when the copy control information of the first additional information and the second additional information do not conflict.
